(19) United States
(12) Patent Application Publication
(10) Pub. No.: US 2024/0219191 A1
(43) Pub. Date: Jul. 4, 2024

(54) METHOD, APPARATUS, AND SYSTEM FOR PROVIDING CONTEXT SENSITIVE NAVIGATION ROUTING

(71) Applicant: HERE Global B.V., Eindhoven (NL)

(72) Inventors: Justin EYLANDER, Chicago, IL (US); Yao LI, Chicago, IL (US); Ina WECHSUNG, Chicago, IL (US)

(21) Appl. No.: 18/404,057

(22) Filed: Jan. 4, 2024

Related U.S. Application Data
(60) Provisional application No. 63/437,036, filed on Jan. 4, 2023.

(51) Int. Cl. G01C 21/34

(52) U.S. Cl. CPC G01C 21/3469

(57) ABSTRACT

An approach is provided for context sensitive routing. The approach, for example, involves collecting sensor data from one or more in-vehicle sensors of a vehicle. The approach also involves processing the sensor data to determine one or more contextual parameter signals associated with the vehicle, one or more passengers of the vehicle, or a combination thereof. The approach further involves determining a context associated with a trip engaged by the vehicle or the one or more passengers based on the one or more contextual parameter signals. The approach further involves determining a routing cost factor based on the context and then determining a navigation route, navigation guidance information, or a combination thereof based on the routing cost factor. The approach further involves providing the navigation route, the navigation guidance information, or a combination thereof as an output.

### BACKGROUND

Mapping and navigation service providers face significant technical challenges with respect to providing navigation routing and guidance that is personalized to individual users. Generally, no two journeys are the same. Routes taken by different users or even the same user under different contexts (e.g., work, school, shopping, etc.) are different. Accordingly, automatically determining these different contexts and the types of navigation routing and guidance preferred under these different contexts present technical problems to overcome.

### SOME EXAMPLE EMBODIMENTS

Therefore, there is a need for providing context sensitive navigation routing.

According to one embodiment, a method comprises collecting sensor data from one or more in-vehicle sensors of a vehicle. The method also comprises processing the sensor data to determine one or more contextual parameter signals associated with the vehicle, one or more passengers of the vehicle, or a combination thereof. The method further comprises determining a context associated with a trip engaged by the vehicle or the one or more passengers based on the one or more contextual parameter signals. The method further comprises determining a routing cost factor based on the context. Examples of the routing cost factor include but are not limited to an efficiency factor, a resilience factor, a reliability factor, a simplicity of route factor, a safety factor, a point of interest discovery factor, or a combination thereof. The method further comprises determining a navigation route, navigation guidance information, or a combination thereof based on the routing cost factor. The method further comprises providing the navigation route, the navigation guidance information, or a combination thereof as an output.

According to another embodiment, an apparatus comprises at least one processor, and at least one memory including computer program code for one or more computer programs, the at least one memory and the computer program code configured to, with the at least one processor, cause, at least in part, the apparatus to collect sensor data from one or more in-vehicle sensors of a vehicle. The apparatus is also caused to process the sensor data to determine one or more contextual parameter signals associated with the vehicle, one or more passengers of the vehicle, or a combination thereof. The apparatus is further caused to determine a context associated with a trip engaged by the vehicle or the one or more passengers based on the one or more contextual parameter signals. The apparatus is further caused to determine a routing cost factor based on the context. Examples of the routing cost factor include but are not limited to an efficiency factor, a resilience factor, a reliability factor, a simplicity of route factor, a safety factor, a point of interest discovery factor, or a combination thereof. The apparatus is further caused to determine a navigation route, navigation guidance information, or a combination thereof based on the routing cost factor. The apparatus is further caused to provide the navigation route, the navigation guidance information, or a combination thereof as an output.

According to another embodiment, a non-transitory computer-readable storage medium carries one or more sequences of one or more instructions which, when executed by one or more processors, cause, at least in part, an apparatus to collect sensor data from one or more in-vehicle sensors of a vehicle. The apparatus is also caused to process the sensor data to determine one or more contextual parameter signals associated with the vehicle, one or more passengers of the vehicle, or a combination thereof. The apparatus is further caused to determine a context associated with a trip engaged by the vehicle or the one or more passengers based on the one or more contextual parameter signals. The apparatus is further caused to determine a routing cost factor based on the context. Examples of the routing cost factor include but are not limited to an efficiency factor, a resilience factor, a reliability factor, a simplicity of route factor, a safety factor, a point of interest discovery factor, or a combination thereof. The apparatus is further caused to determine a navigation route, navigation guidance information, or a combination thereof based on the routing cost factor. The apparatus is further caused to provide the navigation route, the navigation guidance information, or a combination thereof as an output.

In addition, for various example embodiments described herein, the following is applicable: a computer program product may be provided. For example, a computer program product comprising instructions which, when the program is executed by a computer, cause the computer to perform any one or any combination of methods (or processes) disclosed.

According to another embodiment, an apparatus comprises means for collecting sensor data from one or more in-vehicle sensors of a vehicle. The apparatus also comprises means for processing the sensor data to determine one or more contextual parameter signals associated with the vehicle, one or more passengers of the vehicle, or a combination thereof. The apparatus further comprises means for determining a context associated with a trip engaged by the vehicle or the one or more passengers based on the one or more contextual parameter signals. The apparatus comprises means for determining a routing cost factor based on the context. Examples of the routing cost factor include but are not limited to an efficiency factor, a resilience factor, a reliability factor, a simplicity of route factor, a safety factor, a point of interest discovery factor, or a combination thereof. The apparatus further comprises means for determining a navigation route, navigation guidance information, or a combination thereof based on the routing cost factor. The apparatus further comprises means for providing the navigation route, the navigation guidance information, or a combination thereof as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing context-sensitive routing, according to one embodiment;

FIG. 2 is a diagram illustrating example factors for providing context-sensitive routing, according to one embodiment;

FIG. 3 is a diagram illustrating vehicle range data sets for providing context-sensitive routing, according to one embodiment;

FIGS. 4 and 5 are diagrams illustrating services associated with context-sensitive routing, according to one embodiment;

FIG. 6 is a diagram illustrating example factors for personalized search and routing, according to one embodiment;

FIG. 7 is a diagram illustrating the technologies of the system used in the example use case of FIG. 10, according to one embodiment;

FIGS. 8A and 8B are diagrams of an example system architecture for context-sensitive routing, according to one embodiment;

FIG. 9 is a flowchart summarizing a process for providing context-sensitive routing, according to one embodiment;

FIG. 10 is a diagram of a geographic database, according to one embodiment;

FIG. 11 is a diagram of hardware that can be used to implement an embodiment;

FIG. 12 is a diagram of a chip set that can be used to implement an embodiment; and

FIG. 13 is a diagram of a mobile terminal (e.g., handset or vehicle or part thereof) that can be used to implement an embodiment.

### DESCRIPTION OF SOME EMBODIMENTS

Examples of a method, apparatus, and computer program for providing context-sensitive routing are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

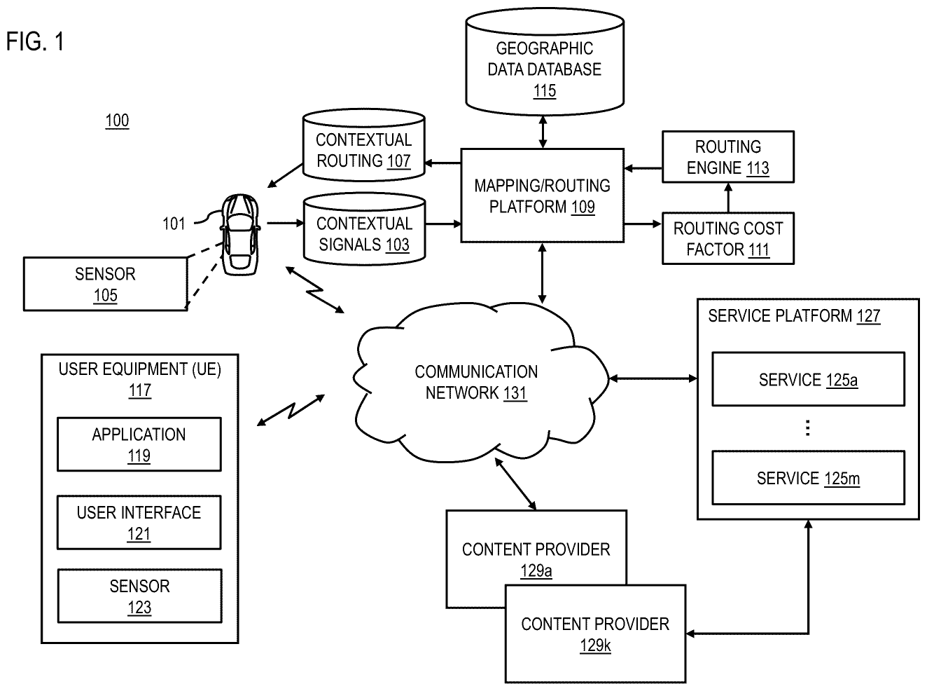

FIG. 1 is a diagram of a system 100 capable of providing context-sensitive routing, according to one embodiment. The current generation of in vehicle navigation solutions have a limited understanding of the context of the vehicle, its driver/passengers, and the environment it operates, thereby limiting its ability to provide positive experiences to drivers on their journeys. No two journeys are the same. For example, a route to work, school, or the mall, from door to door, is different for one user versus other users. So too are users' driving styles, preferred stops and the weather and traffic that are encountered along the way. As a result, many users may ultimately ignore or stop using navigation systems because they may fail to offer navigation and/or navigation guidance that do not meet the users' preferences. Traditional approaches often require users to manually input routing preferences and options, which can be cumbersome to end users as well as not fully cover all driving situations they users may encounter.

To address these technical challenges, the various embodiments of the system 100 are based on developing a solution that learns from individual users' unique mobility habits with respect to vehicle 101 under many different contexts (e.g., determined using contextual signals 103 determined from vehicle sensors 105) to offer personalized guidance and journey recommendations (e.g., contextual routing 107). More specifically, the system 100 introduces a capability to:

### (1) Learn User Pattern and Preferences

Observe typical and atypical trips (e.g., in vehicle 101) as well as user navigation decisions made during the trips. These observations include but are not limited to the system 100's location intelligence data, sensor data, and user data (bring-your-own-data option) (e.g., comprising contextual signals 103). The system 100 is committed to protecting user's privacy based on GDPR standards. In one embodiment, the system 100 relies on precise location for speed limits, road features and localization to observe typical and atypical trips and decisions and incorporate user data using bring your-own-data option.

### (2) Personalize Routing and Search Experience

In one embodiment, the system 100 (e.g., via mapping/routing platform 109) provides a “just-for-me” routing and search experience (e.g., contextual routing 107). The system 100 factors in contextual signals 103 such as but not limited to trip context, including journey intention, and external factors (e.g., predicted traffic, weather, etc.), as well as a user's preference, such as hands-free driving, local business over chain stores, etc. For example, the system 100 can use the contextual signals 103 and/or the contexts of a trip determined therefrom to select one or more routing cost factors 111 that its routing engine 113 (or any equivalent routing algorithm) can use to generate or recommend a navigation route. Routing cost factors 111 refers, for instance, to one or more sets of parameters/rules/etc. that the routing engine will use to determine what routes to recommend or present (e.g., based on minimizing or maximizing selected routing cost factors 111). Examples of the routing cost factors 111 include but are not limited to: (1) efficiency factors—e.g., electric vehicle/fuel consumption and carbon footprint; (2) resilience factors'e.g., having available back-up options in case a route segment is congested or affected by accidents; (3) reliability factors—e.g., ability to reach a destination before the vehicle 101's battery or fuel runs out; (4) simplicity of route factors—e.g., minimizing number of road type changes, complex maneuvering, difficult decisions such as roundabouts, etc.; (5) safety factors—e.g., protect vulnerable road users by routing away from transportation hubs, school zones during student pick-up/drop-off hours, religious service centers, etc.; and (6) point-of-interest (POI) discovery factors—e.g., explore interesting routes with POIs aligned with the user's personal hobbies, preferences, etc. For example, a digital concierge component of the mapping/routing platform 109 can interact with the routing engine 113 and a geographic database 115 to recommend the most desirable routes and curated stops with destination services (e.g., based on user preferences, historical mobility data, etc.) based on the selected routing cost factors 111.

### (3) Adjust Based on Real-Time Updates Using OTA

In one embodiment, the system 100's curated routing and navigation recommendations can be further optimized by observing ongoing trips and decisions. In this way, the system 100 responds to context changes, such as but not limited to traffic built-up or driver distraction. The system 100 also adds new insights about user patterns and preferences (e.g., mobility patterns and preferences). In one embodiment, the system 100's machine-learning based algorithms and models continue to learn and adapt using fresh observations and dynamic context changes.

By way of example, for busy families juggling multiple morning stops, the system 100 can utilize learned journey patterns and driver preferences. Using seat sensors (or any other equivalent in-vehicle sensor) (e.g., sensors 105) to confirm passengers and dynamic detection of delayed driver reactions. In cases where the system 100 detects potentially distracting contexts (e.g., busy morning drop-off of kids), the system 100 can select corresponding routing cost factors 111 that engage Simple mode routing algorithms, for instance, to optimize hands-free driving and minimize complex decisions throughout the journey or trip.

In one example use case, a car crash has been flagged with predicted traffic build-up, rendering current route unusable. A user is presented with alternative options. For example, the options can be presented on an in-vehicle navigation system/device or via a user equipment (UE) device 117 executing an application 119 (e.g., navigation or other location-based applications) to generate a user interface 121. In one embodiment, UE 117 can also include sensors 123 for determining contextual signals 103. In this example, from among the presented alternative options, the user chooses the reliable in-range route to ensure on-time arrival at work, despite it being the most expensive. In other words, the reliable in-range route is generated by selecting corresponding routing cost factors 111 to configure the routing engine 113 to generate a route that has a higher probability of ensuring that the user can reach the destination before running out of battery, fuel, or other power source. This is because, in this example, the vehicle 101 was not re-charged overnight, so the user is presented with charge-point attached parking options, pre-filtered based on current availability and EV adaptor compatibility to ensure a reliable route (e.g., reliability factor as at least one of the selected routing cost factors 111). The options are ranked by user preference (closest to the work entry point and bookable). Filtering by possible and ranged by desirable can further be applied. In other words, Reliable mode routing algorithm ensures on-time arrival at work, utilizing multiple back-up options and filters based on remaining EV charge range, deprioritizing cost and distance travelled based on selecting the routing cost factors 111 that correspond to the determined context (e.g., low charge and traveling to work that must be reached on time).

Continuing with the example, on Wednesday morning, based on historical patterns, the system 100 assumes that the user will be dropping off children at school, before going to work. After a rough night of minimal sleep, the user loads children, confirmed by the seat sensor (e.g., vehicle sensor 105), into the uncharged vehicle 101. The user almost hits a pedestrian while exiting the parking lot. Luckily, the system 100 recognizes the user is not paying attention and engages automated emergency stop (e.g., by evaluating contextual signals 103 determined based on sensors 105, intended destination, activity, and/or other historical data). The journey consists of two stops: school and the office. The vehicle 101 suggests the route with the highest percentage of automation (system advisory). The children get into an argument. The system 100 detects the user's delayed response (e.g., via in-vehicle sensors 105 and inputs to the vehicle 101) and advises other system components. Based on an in-vehicle sound sensor 105, the system component (e.g., mapping/routing platform 109) suggests a free 1-hour trial of multiple source entertainment (different content on different screens), the user gladly accepts. The system 100 also triggers “simple route” mode to minimize complex decisions such as roundabouts. In addition, the system 100 issues advanced warning for highway exit with additional time to account for the delayed reaction. The driver supervises highway off-ramp and merges into local traffic. These actions are performed automatically by the system 100 in response to the detected contextual signals 103 and associated contexts which can be used to select routing cost factors 111 for the routing engine 113 to use to generate corresponding navigation routes and/or navigation guidance information.

Continuing with the example, the vehicle 101 was not re-charged overnight, so the user is presented with charge-point attached parking options, pre-filtered based on current availability and EV adaptor compatibility. As described with the previous example, the options are ranked by user preference (closest to the work entry point and bookable).

Therefore, as illustrated in this example, by learning from the user's unique mobility habits (e.g., comprising contextual signals 103 and associated contexts), the system 100 can offer personalized guidance—from preferred routes and stops, to a good place to charge and park by selected the routing cost factors 111 associated with the user's or vehicle 101's context. This provides a solution that continually adapts to the user's needs through learned (e.g., machine learned) contexts and options for configuring the routing engine 113 without explicit user input to change the routing options.

In summary, according to the various embodiments described herein, the system 100 uses sensors (e.g., in-vehicle sensors—such as seat sensors/in-vehicle cameras, etc.—and/or sensors 123 of UEs 117) to consider passengers and additional context including number of occupants, weight/age of occupants, time of day, and previous destinations associated with those contextual signals 103. The system 100 can then infer the context of a trip (e.g., drop-off at school before going to work). Moreover, as previously described, the system 100 factors in other considerations (e.g., routing cost factors 111) such as but not limited to:
efficiency (EV/fuel consumption and carbon footprint);
resilience (available back-up options in case of congestion/accidents);
reliability (can you get there before the battery/fuel runs out);
simplicity of route (road type changes, complex maneuvering, difficult decision such as roundabouts);
safety (protect vulnerable road users by routing away from transportation hubs, school zones during pick-up/drop-off hours, and religious service centers); and
maximize discovery (explore interesting routes with POIs aligned with the users' personal hobbies).

In one embodiment, the system 100 helps a trip planner component (e.g., mapping/routing platform 109) to prioritize destinations by catering to multi-task stop options (e.g., ATM/grocery/restaurant/cafe) as well as suggest alternative destinations (e.g., for a different beach when there are riptides at a selected beach, or a different mall when there is heavy traffic going to a selected mall). In another embodiment, the system 100 factors in bundled offers (e.g., fleet management service pre-negotiated discount parking chains) when determining navigation routing and/or guidance options/recommendations. These offers, for instance, can be associated with one or more services 125a-125m (also collectively referred to as services 125) of a services platform 127 and/or one or more content providers 129a-129k (also collectively referred to as content providers 129) accessible over a communication network 131.

In one embodiment, the system 100 uses an additive model to aggregate/discount information (e.g., via routing cost factors 111) based on relevancy to the individual context. It is noted that this model is provided by way of illustration and not as a limitation. Accordingly, it is contemplated that any other equivalent model can be used according to the various embodiments described herein.

As discussed, the various embodiments of the system 100 are directed to solving specific technical challenges. For example, technical challenges associated with providing a system architecture for context-sensitive or personalized routing are generally divided into categories including but not limited to: (1) access to data; (2) standardization; (3) user experience; and (4) incentive to collaborate.

For example, with respect to access to data, the challenges include:
App developers who need data to provide a personal experience do not always have access to data;
Restrictions around how data could be used (e.g., personal/vehicle data); and
Restrictions around data retention, preventing learning over time.

To address these challenges, the system 100 provides the following features:
The system's knowledge of the world, static and dynamic; and
Vehicle & personal data from the system.

With respect to standardization, the challenges include:
Different collection systems and data repositories;
No consistent application programming interface (API) to access data, and it can be difficult for app developers to utilize the data; and
Impossible to control and coordinate standards across original equipment manufacturers (OEMs), who see each other as competitors.

To address these challenges, the system 100 provides the following features:
The system 100 or mapping/routing platform, e.g., provided by a vendor to OEMs, puts a flexible common platform in the vehicle 101 directly through OEMs.

With respect to user experience, the challenges include:
Companies with data prioritizes advertising revenue;
Herding user into a single destination based on most recent activities;
Tunnel vision and user experience is stuck with only like-minded content; and
High incentive to potentially misuse data, resulting in mistrust and tendency for users to withhold data.

To address these challenges, the system 100 provides the following features:
The system 100 learns over time and gets incrementally better; and
The system 100 learns through users with similar profile and prioritize using page rank like algorithm.

With respect to incentive to collaborate, the challenges include:
Different companies have access to different aspects of data; and
Tend to build competing services, with no incentive to cooperate and share data.

To address these challenges, the system 100 provides the following features:
The system 100 provides a common platform that offers a compelling full-stack solution (e.g., from collecting contextual signals 103 to delivery of contextual routing 107).

By way of example, developmental stages for providing context-sensitive routing can be described various stages, according to one embodiment. In this example, stage 1 refers to the current state of dynamic search and routing. Stage 1 provides no new technology over the state of the art but provides the benefit of global coverage and provides for accurate search and routing that can be used to find where to go and how to get there.

In one embodiment, Stage 2 “Predictive routing” introduces a new technology for detecting vehicle range (e.g., battery range for electric vehicles or fuel range for conventional vehicles) using a predictive machine learning (ML) model. In this way, the mapping/routing platform 109 can make dynamic adjustments to navigation routing and guidance based on the predicted range. In one embodiment, the predictive ML model can also consider changes based real-time contextual parameters such as but not limited to weather, traffic, etc. In this way, the mapping/routing platform 109 can provide a predictive estimated time of arrival (ETA) and/or vehicle range as a service.

In one embodiment, Stage 3 “Personalized Search and Routing” introduces a new technology for detecting user behavior and vehicle efficiency using a predictive ML model. The ML model, for instance, can be based on an unsupervised learning service (or equivalent ML algorithm) to provide collective user behavior and pattern detection using ML insight modeling. This user behavior and insight modeling enables the mapping platform to provide “just-for-me” routing that is based on learned user behavior that is responsive to user-specific preferences and behaviors. In this way, the mapping/routing platform 109 can provide driver/user-based vehicle range (e.g., EV/fuel range) and charge-point recommendations as a service.

In one embodiment, Stage 4 “Curated Recommendations” introduces a new technology for using an intention-based relevancy filter based on user preference ML models and user-defined schema. An intention-based approach enables the mapping/routing platform 109 to support multi-task and intention-based routing requests which reduces the mental load of the driver (e.g., by routes reflecting intended purposes of the trip or journey such as reliable mode routes, simplicity mode routes, sustainability mode routes, scenic mode routes, safety mode routes, etc.) without depending on the driver to make detail routing parameter selections. In this way, the mapping/routing platform 109 can support more complex multi-errands stop (e.g., trips comprising stops for fuel, shopping, banking, playground visits, etc. in one journey) based on the user preference ML model to minimize user decision making and mental load.

In one embodiment, Stage 5 “Integrated Journey” introduces a new technology for pattern analysis and querying across tensor field (e.g., across multiple predictive ML models) to provide a complete end-to-end assist for navigation routing and guidance. This end-to-end assist includes but is not limited to pre-trip planning, multi-modal trips, post-trip coaching, etc. In one embodiment, the end-to-end assist also includes predictive maintenance inspection and repair when planning routing requests (e.g., recommending an oil or tire change before completing a long trip).

In one embodiment, the system 100 provides an intelligent guide implementation for context-sensitive routing. By way of example, the intelligent guide implementation reduces the mental load on drivers or users of vehicles 101 by optimizing navigation routing/map searches (e.g., via routing cost factors 111) based on individual preferences. In one embodiment, the intelligent guide implementation is based on at least the following components: (1) an efficiency coach component; (2) a safer routing component; and (3) a digital concierge component. The efficient coach component provides a service for estimating a reliable vehicle operating range based on one or more of the following:
Vehicle efficiency ML model—a predictive model used to compute an estimated range of a vehicle based on its fuel/charge levels (e.g., max levels, current levels, minimum levels, etc.);
Driver behavior ML model—a predictive model used to predict a user's driving behaviors, patterns, preferences, etc., where such behaviors or patterns can affect the effective range of a vehicle (e.g., vehicle speed, braking patterns, acceleration patterns, types of common maneuvers, etc.); and
Context—data indicating road characteristics, traffic, weather, and/or the like occurring on a planned route that may affect the efficiency of the vehicle (e.g., cold weather reducing EV battery efficiency, poor asphalt contributing to reduced efficiency, etc.).

In one embodiment, the safer routing component can make automatic route adjustments upon detection of potential safety issues (e.g., delayed reactions by the driver). For example, when conditions that potentially affect the safe operations of a vehicle (e.g., driver distraction, vehicle maintenance issue, driving areas populated with vulnerable road users (VRUs), etc.) are detect, the safer routing component can initiate mitigating actions such as but not limited to:
Routing to reduce complex decisions by the driver (e.g., routing to avoid roundabouts or other features that require driver complex decisions or higher levels of attention);
Routing to protect unexpected VRUs (e.g., routing through areas with no or fewer detected VRUs or to avoid particular types of VRUs such as school-aged pedestrians);
Routing to maximize familiar roads (e.g., routing to use roads that a user has travel before or uses above a threshold number of uses); and
Optionally providing notification feedback to a user interface provider or service about the detected safety issue (e.g., this can also be optionally accompanied by autonomous action to mitigate the issue when operating an autonomous vehicle).

In one embodiment, the digital concierge component can be used to determine the desirability of a route for particular users (e.g., by predictive ML, user preferences, manual selection, etc.). The desirability of a route can be specified or predicted as different routes categories or classifications that can be associated with a set of routing preferences for selecting corresponding routes (e.g., routing cost factors 111). For example, as discussed previously, the categories can include but are not limited to reliable mode, simple/safe mode, explore/scenic mode, sustainable mode, etc. As mentioned, based on the route characteristics associated with each category, the digital concierge component can configure the routing engine 113 with corresponding routing cost factors 111 to select “just-for-me” stops personalized to the user based on the specified category or context. The concierge service can also provide multi-task options whereby the user can specify multiple tasks or errands to be performed and then the routes meeting selected category criteria (e.g., reliable, simple, explore, sustainable, etc.) can be automatically chosen and/or recommended. In one embodiment, the digital concierge component can provide for “look-ahead” features that can account for future changes in contextual parameters during a trip (e.g., changes in traffic, weather, etc. that occur or are predicted to occur on route). In yet another embodiment, the digital concierge component can provide destination services (e.g., reserving resources at the destination, providing information about the destination, arranging for purchases/pick-up of goods, etc.).

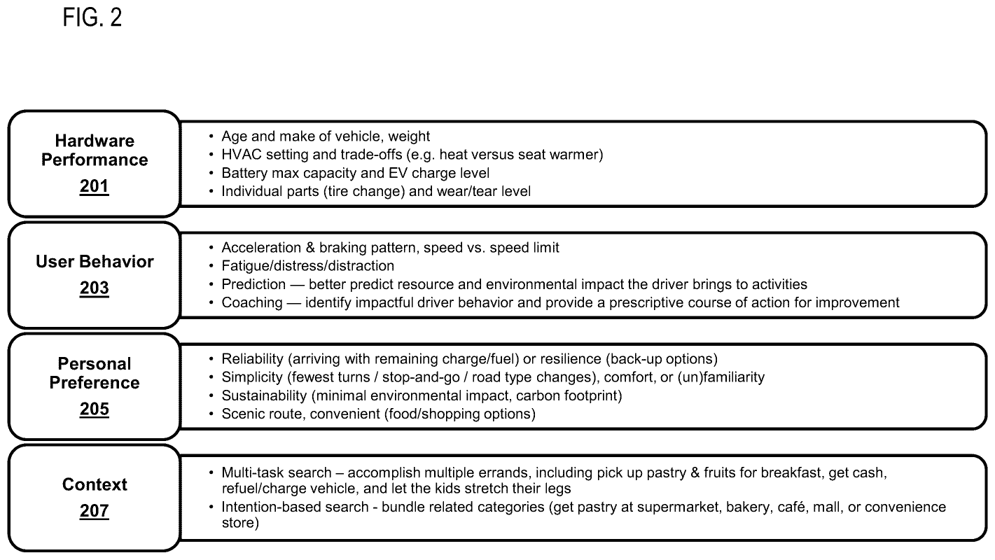

FIG. 2 is a diagram illustrating example factors for providing context-sensitive routing, according to one embodiment. As discussed above, the system 100 can consider factors (e.g., as input features to predictive ML models) such as but not limited to:
(1) Hardware performance 201—the performance of the vehicle and/or related components such as the age, make, weight, etc. of the vehicle; settings of the vehicle (e.g., HVAC settings); and operating condition (e.g., battery/fuel capacity or level, condition of individual parts and general wear and tear (e.g., tires and other components of the vehicle that are subject to wear from use; damage to the components, etc.).
(2) User behavior 203—the driving behavior of the driver (e.g., acceleration and braking patterns, speed vs. speed limit); condition of the driver (e.g., fatigue, distress, distraction as detected by in-vehicle sensors); predicted resource and/or environmental impact the driver brings to activities; and coaching to identify impactful driver behavior and provide a prescriptive course of action for improvement.
(3) Personal preference 205—preference expressed based on the desirability of route based on certain route categories such as but not limited to: (1) reliability (arriving with remaining charge/fuel) or resilience (back-up options); (2) simplicity (fewest turns/stop-and-go/road type changes), comfort, or (un)familiarity; (3) sustainability (minimal environmental impact, carbon footprint); and (4) Scenic route, convenient (food/shopping options).
(4) Context 207—based on search types such as but not limited to: (1) multi-task search—accomplish multiple errands, including pick up pastry and fruits for breakfast, get cash, refuel/charge vehicle, and let the kids stretch their legs; and (2) intention-based search—bundle related categories (get pastry at supermarket, bakery, café, mall, or convenience store).

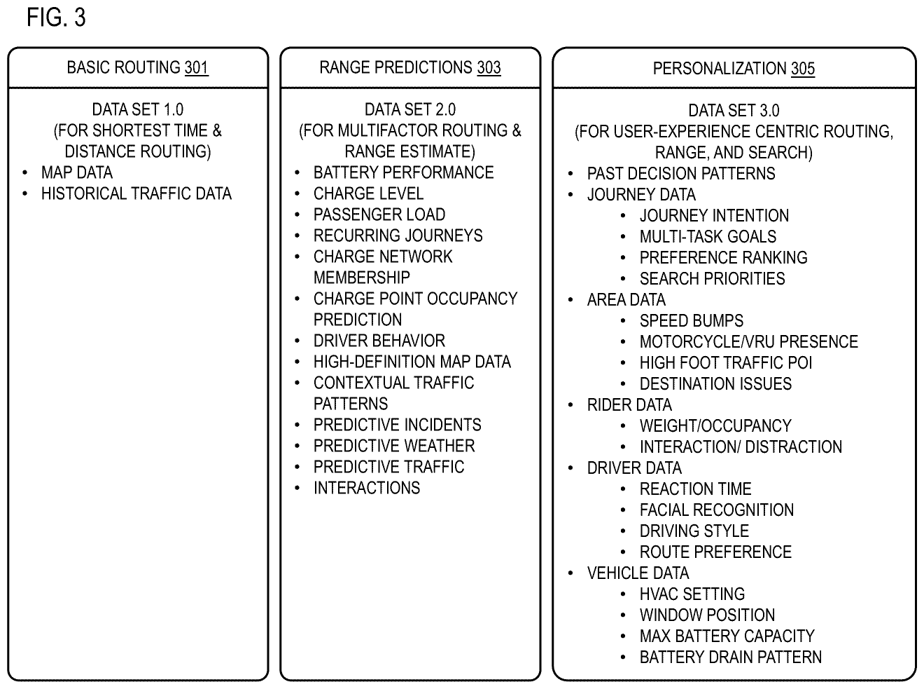

FIG. 3 is a diagram illustrating vehicle range data sets for providing context-sensitive routing, according to one embodiment. As previously described, predicting vehicle range is one factor in determining context-sensitive routing. The example of FIG. 3 illustrates three example sets of vehicle (e.g., EV) range data sets that can support increasingly sophisticated range forecasts: data set 1.0 for basic routing 301, data set 2.0 for range predictions 303, and data set 3.0 for personalization 305. For example, data set 1.0 can be used to support “Basic Routing” 301. Data set 1.0 includes map data (e.g., digital map data of a geographic database 115) and historical traffic data. This data set 1.0 can be used by a shortest time and distance routing engine 113 to compute basic routes such as shortest time or distance routes.

As shown, data set 2.0 can be used for “Range Predictions” 303 and include a richer set of data elements including but not limited to: battery performance, charge level, passenger load, recurring journeys, charge network membership, charge point occupancy prediction, driver behavior, High Definition map data (e.g., HD map of the geographic database 115), contextual traffic patterns, predictive incidents on route, predictive weather (e.g., temperature), predictive traffic, interactions (e.g., starts, stops). These data elements can be used by a multi-factor routing and range engines comprising ML prediction models, vehicle data, range services from the mapping platform, or a combination thereof.

In this example, data set 3.0 is the most complex model and can be used for “Personalization” 305 of navigation routing and guidance. As shown, data set 3.0 includes but is not limited to: (1) pattern data comprising past decisions, other user decisions under similar contexts, similar users under and different contexts; (2) journey data comprising journey intention, multi-task goals, preference ranking, and search priorities; (3) area data comprising speed bumps, motorcycle and VRU presence, high foot traffic points of interest, and destination issues; (4) rider data comprising weight/occupancy (e.g., determined using in-vehicle seat weight sensors or equivalent sensors), and interaction/distraction status (e.g., determined using in-vehicle cameras or equivalent sensors); (5) driver data comprising reaction time data, facial recognition data, driving style, and route preference; and (6) vehicle data comprising HVAC setting, window position, max battery capacity, and batter drain pattern. The data set 3.0 elements can be processed using a user-experience centric routing, range, and search engines (e.g., including or otherwise relying on ML prediction models).

In one embodiment, the different data sets 1.0-3.0 described can provide for different levels of analysis or insight that can be used for context-sensitive routing. With respect to in-vehicle data, examples of a “simple” insight include determining:
(1) a cost/benefit tradeoff for HVAC settings (e.g., trade off=heat versus seat warmer+open window (e.g., causing aerodynamic drag)); and
(2) range capacity=maximum battery capacity.

Examples of “complex” insight include but are not limited to:
(1) Battery drain forecast=max charge+historical drain pattern;
(2) Driver style=speed vs. speed limit+consistency in decisions (swerving, acceleration/breaking pattern);
(3) Driver focus=reaction time deviation+source of distraction (passenger location+children vs. adults)+eye gaze matching location of VRU; and
(4) Driver profile=facial recognition using driver facing camera.

With respect to context data, examples of a “simple” insight include determining:
(1) Non-regenerative braking=maneuver around jaywalking pedestrians (crowded area or high-foot traffic POIs); and
(2) Rewards program=higher ranking for preferred brands.

Examples of “complex” insight include but are not limited to:
(1) Intention-based search=(category combination) purchasing pastry at bakery or convenience store or café; and
(2) Desirability of route=different depending on user's preference and journey type
   Reliability (confidence of arriving with remaining charge);
   Resilience (multi-route back-up options);
   Simplicity (fewest turns/road type changes/multi-road intersections);
   (un)familiarity (minimize new decision points or open to exploring);
   Sustainability (minimal carbon footprint); and
   Scenic or convenient (food/shopping options).

In one embodiment, the data sets 1.0-3.0 also support collective learning (e.g., via ML prediction models) for parameters such as but not limited to:
(1) Minimum user identity exposure=what did other users choose in similar context;
(2) Limited user profile exposure=what did similar user (partial profile for categorization) or vehicle do in different context; and
(3) Full user profile exposure=historical decision made by the same user.

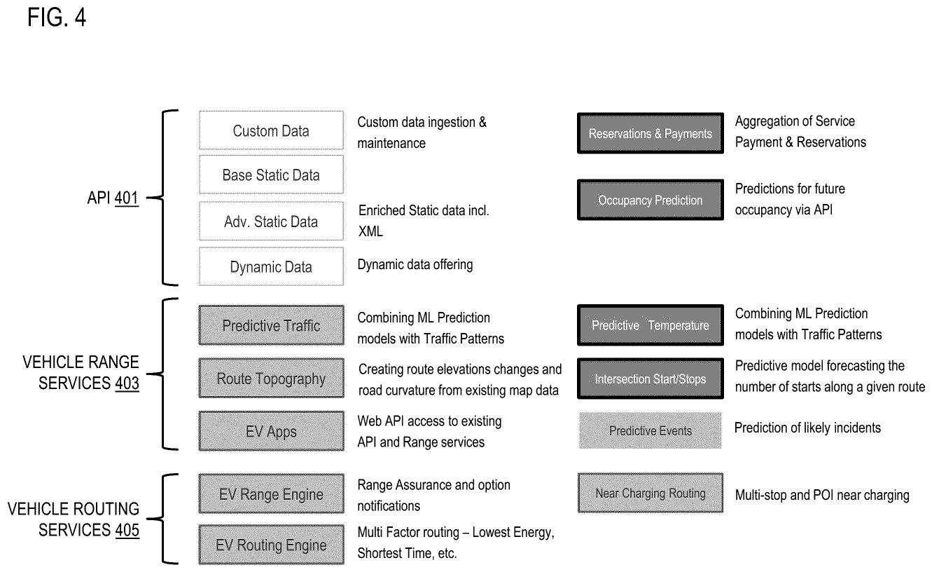

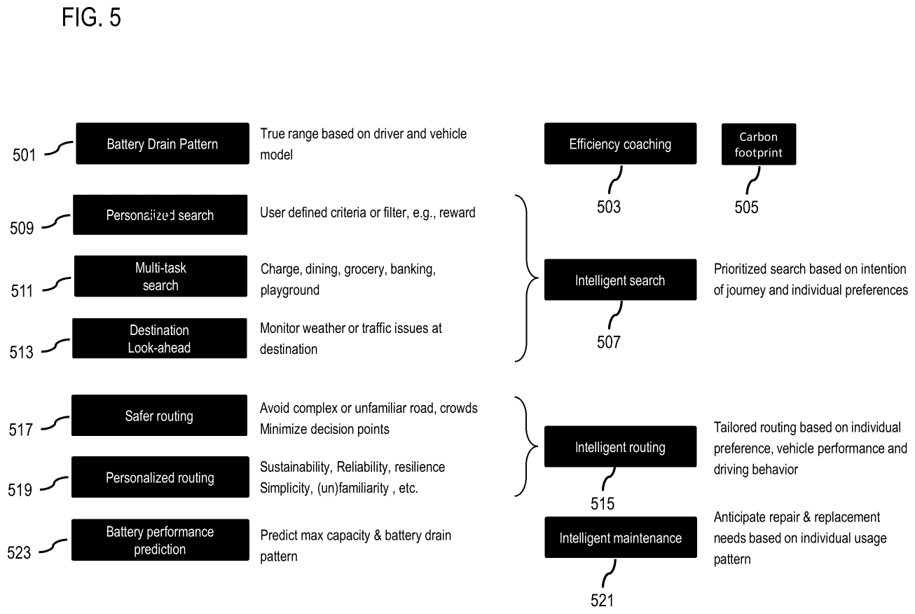

FIGS. 4 and 5 are diagrams illustrating services associated with context-sensitive routing, according to one embodiment. As shown in FIG. 4, in one embodiment, the system 100 provides an application programming interface (API) 401 to access data including but not limited to (1) custom customer data (e.g., the data sets described with respect to FIG. 3 for custom ingestion and maintenance into the system 100); (2) base static data; (3) advanced static data; (4) dynamic data; (5) reservations and payments data (e.g., for services 125 enroute such as but limited to charging/fueling services); and (6) occupancy data (e.g., prediction of future occupancy). The system 100 also provides access to vehicle (e.g., EV) range services 403 including but not limited to: (1) predictive traffic (e.g., combining ML prediction models with traffic patterns); (2) route topography (e.g., creating route elevations changes and road curvature from existing map data; (3) EV applications (e.g., web API access to range services; (4) predictive temperature (e.g., combining ML prediction with traffic patterns); (5) intersection starts/stops (e.g., predictive model forecasting the number starts along a given route); and (6) predictive events (e.g., prediction of likely incidents enroute). The system 100 further provides vehicle routing and range services 405 including but not limited to: (1) vehicle (EV) range engine (e.g., range assurance and related notifications); (2) vehicle (EV) routing engine (e.g., multi-factor routing—lowest energy, shortest time, specific MSP/CPOs); and (3) Near Charging Routing (e.g., multi-stop and POI near charging).

FIG. 5 illustrates additional services for the system 100. For example, the services include but are not limited to: (1) battery drain pattern 501 (e.g., true range based on driver and vehicle model) including efficiency coaching 503, carbon footprint 505, and/or any other related environmental impact factors; (2) intelligent search 507 (e.g., prioritized search based on intention of journey and individual preferences based on personalized search 509 (e.g., user defined criteria or filter such as reward), multi-task search 511 (e.g., charge, dining, grocery, banking, playground, etc.), and destination look-ahead 513 (e.g., monitor weather and/or traffic issues at destination); (3) intelligent routing 515 (e.g., tailored routing based on individual preference, vehicle performance, and driving behavior) comprising safer routing 517 (e.g., avoid complex or unfamiliar roads, crowds, and/or minimize decision points) and personalized routing 519 (e.g., sustainability, reliability, resilience, simplicity, (un)familiarity, etc. modes); and (4) intelligent maintenance 521 (e.g., anticipate repair and replacement needs based on individual usage pattern including battery performance prediction 523 (e.g., predict maximum capacity and drain pattern).

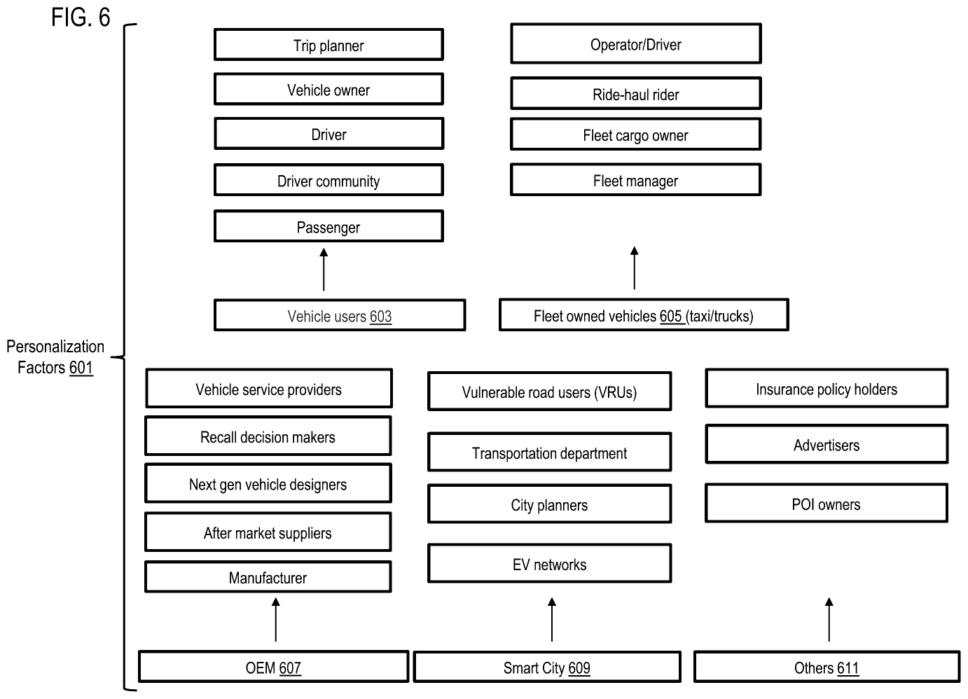

FIG. 6 is a diagram illustrating example factors 601 for personalized search and routing, according to one embodiment. In one embodiment, personalized search and routing can be provided as a service for a variety of users including but limited to: (1) vehicle users 603 (e.g., trip planner, vehicle owner, driver, driver community, and/or passenger); (2) fleet owned vehicles 605 (e.g., taxis/trucks) such as operator/driver, ride-haul rider, fleet cargo owner, and fleet manager; (3) original equipment manufacturers (OEMs) 607 (e.g., vehicle service providers, recall decision makers, next generation vehicle designers, after market suppliers, and manufacturers); (4) smart cities 609 (e.g., vulnerable road users (VRUs), transportation department, city planners, and EV networks); and (4) others 611 (e.g., insurance policy holders, advertisers, and POI owners).

In one embodiment, guiding principles for personalized or context-sensitive routing include but are not limited to: (1) reduce mental load—for user using known preferences and learned preferences based on past decisions (e.g., favorites, common commute, historical mobility patterns, etc.); (2) multi-task and intention-based requests—bundle related categories (e.g., get pastry at supermarket, bakery, café, mall, kiosk, or convenience store); (3) prioritize options (e.g., ranked on personal profile, preference, past decisions, and selections by people with similar profiles); and (4) individualized ML models (e.g., based on driver behavior, vehicle efficiency, user preference, past choices, user intention/objective, etc.). One example use case of personalized or context-sensitive routing involves an EV driver looking for a charging station and ways to complete multiple errands. The user is a family driving to a rental property during a road trip, and the family has multiple errands, including picking up pastry and fruits for breakfast, getting cash, refueling/charging the vehicle, and let the kids stretch their legs. The problem includes:
For a goal (e.g., get pastry), the user has to search for multiple categories of POIs;
For multiple tasks, the user traditionally must manually combine multiple search results or make multiple stops; and
The most desirable route could differ depending on user's preference for:
   Reliability (arriving with remaining charge/fuel) or resilience (back-up options);
   Simplicity (fewest turns/stop-and-go/road type changes), comfort, or (un)familiarity;
   Sustainability (minimal environmental impact, carbon footprint); and
   Exploration (scenic route, convenient food/shopping options)

Therefore, there is a need to: (1) find a way to satisfy multi-purpose journey; (2) receive prioritize destination results (ideally with multi-tasks); and (3) receive routing recommendation and updates based on personal preference and the context. The various embodiments of the system 100 described herein address this use case through context-sensitive routing.

As shown, other example uses cases include but are not limited to: ETA as a service, carbon footprint reporting; Trip data analytics and historic profiling for better future planning; Smart factory staff routing (certification/permission based); Tourism, advertising, POI browsing; Personal health behavior coaching; Intelligent guide for EV charging, personalized routing, and driving coaching; Customized routing and driver matching; Transportation hub & beyond navigation; Customized routing & resource matching; Cyclist/runner individualized route/search; and Staff/driver navigation & resource matching.

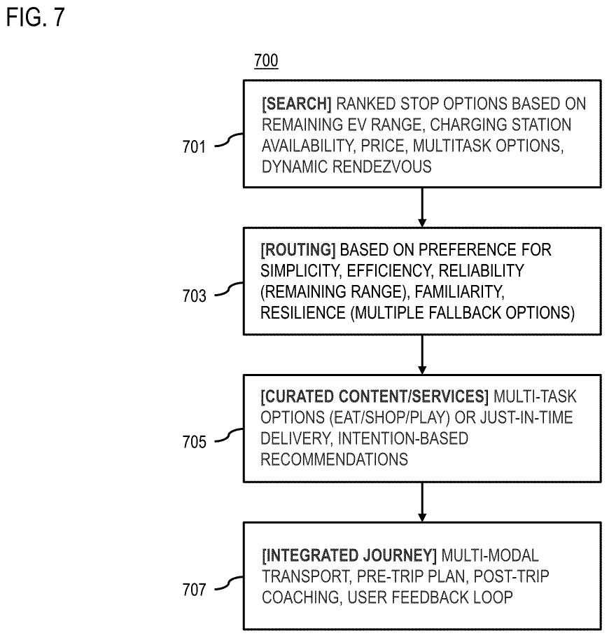

FIG. 7 is a diagram illustrating the technologies of the system 100 used in the example use case of FIG. 6, according to one embodiment. As shown, at process 701, a Search is used to provide ranked stop options based on remaining EV range, charging station availability, price, multitask options, dynamic rendezvous. This process uses POI and EV network data (e.g., stored in the geographic database) to provide Historical driving patterns; Location based relevancy filter; Preference trade-offs; Privacy protection for personal information; and Validation of location.

At process 703, routing is performed based on preference for simplicity, efficiency, reliability (remaining range), familiarity, resilience (multiple fallback options). This process uses User data, Routing, Traffic, Speed Category, Weather, Terrain, Road Characteristics, Past user travel history, and/or (3rd party) past user purchase history (e.g., maintained by the mapping platform and/or geographic database) to provide Preference based relevancy filter; Driver behavior ML model; Vehicle efficiency ML model; weighted search across route segments; and distributed compute for behavior analysis.

At process 705, curated content/services are provided to address multi-task options (eat/shop/play) or just-in-time delivery, intention-based recommendations. This process uses POIs, Search, Routing, and positioning/tracking (e.g., provided by mapping platform and/or geographic database) to provide Intention based relevancy filter; User preference ML model; and User defined schema.

At process 705, an integrated journey is generated based on multi-modal transport, pre-trip plan, post-trip coaching, and user feedback loop. This process uses Routing, POIs, Traffic, Weather, and real-time data (e.g., provided by mapping platform and/or geographic database) to provide Pattern analysis; User defined schema; and Query across tensor field for update based on unexpected decision/behavior.

In one embodiment, the system 100 comprises an ecosystem for providing context-sensitive routing including but are not limited to: (1) Static environmental data (e.g., POIs, terrain, road characteristics); (2) Dynamic environmental data (e.g., traffic, hazard); (3) Services (positioning, routing, edge perception); and (4) ML models. The components of the ecosystem include but are not limited to:

### (1) End Users

Personal data repository
OEM system
Telco user services

### (2) EV Network

Real-time updates
Connector compatibility
Availability and pricing info
Reservation services

### (3) XaaS Payment

Integrated wallet
Usage monitoring
Pay-per-use

### (4) Navigation System

Search services
Real-time adjustments
Learn based on user data and feedback

### (5) Communication System

User interface
Relay requests to EV network
Broadcast update for delivery/reservation
   (6) Partners with Complimentary Services (e.g., Services 125)
Entertainment/retail options
Delivery services
Restaurant reservations

### (7) Others

Public transportation or ride hail
Insurance
Alternative transportation (carpool, 2-wheeler)

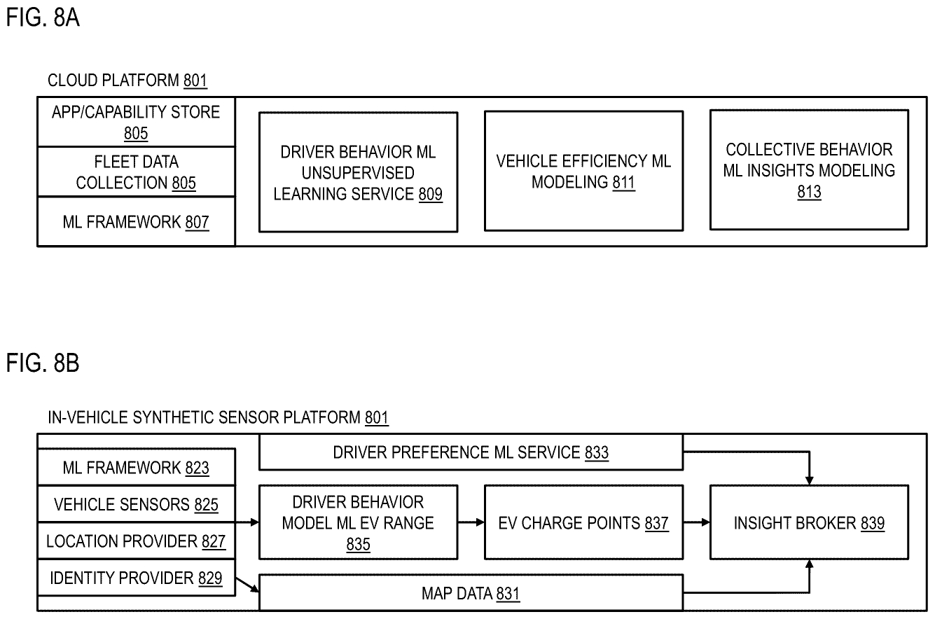

FIGS. 8A and 8B are diagrams of an example system architecture for context-sensitive routing, according to one embodiment. As shown in FIG. 8A, the system architecture includes a cloud platform 801 (e.g., mapping/routing platform 109) comprising: (1) an application/capability store 803 (e.g., for providing applications 119, services 125, functions, etc. to UEs 117, vehicles 101, and/or other client devices), (2) fleet data collection component 805 (e.g., collecting sensor data, historical mobility patterns, etc. from vehicles fleets), (3) ML framework 807 (e.g., for implementing ML models used for context-sensitive routing), (4) driver behavior ML unsupervised learning service 809, (5) vehicle efficiency ML modeling 811, and (6) collective behavior ML insights modeling 813.

As shown in FIG. 8B, the system architecture also includes an in-vehicle synthetic sensor platform 821 (e.g., for detecting vehicle, passenger, and/or contextual data) comprising: (1) ML framework 823, (2) vehicle sensors 825 (e.g., for collecting sensor data indicating contextual signals 103), (3) location provider 827 (e.g., for determining the vehicle's location), (4) identity provider 829 (e.g., for authenticating access to the cloud platform 801 and/or map data 831 such as stored in the geographic database 115), (5) driver preference ML service 833, (6) driver behavior model ML EV range 835, (7) EV charge points 837 (e.g., provide locations, reservations, payments, etc. for charge points enroute), and (9) insight broker 839 (e.g., for combining the inferences made by ML components).

In summary, in one embodiment, an approach to intelligent navigation routing and guidance is provided to reduce mental load on drivers/passengers of vehicles (e.g., autonomous vehicles) when making routing and navigation decisions. The approach, for instance, is based on user preferences (e.g., individual and/or group preferences) specified in preference categories such as, but not limited to: (1) reliability mode (e.g., arriving with remaining charge/fuel) or resilience mode (e.g., provide multiple back-up routing options should one option become unavailable); (2) simplicity mode (e.g., routes with fewest turns/stop-and-go/road type changes), comfort, or (un)familiarity; (3) sustainability mode (e.g., minimal environmental impact, carbon footprint); and (4) scenic route mode/convenient mode (e.g., routes for sightseeing or completing tasks such as shopping options. The preference categories are used as input to a system that evaluates the preferences in combination with other contextual factors to determine routing and guidance information. The other contextual factors include but are not limited to: (1) hardware performance; (2) user behavior; and (3) search context. Examples of hardware performance factors include: (1) age and make of vehicle, weight; (2) HVAC (heating ventilation air conditioning) settings and trade-offs (e.g., heat versus seat warmer); (3) electric vehicle battery max capacity and charge level; and (4) individual parts (e.g., tire change) and/or wear and tear level. Examples of user behavior factors include but are not limited to: (1) acceleration and braking patters, speed vs. speed limit; (2) fatigue/distress/distraction; (3) prediction—better prediction resource and environmental impact that the driver brings to actives; and (4) coaching—identify impactful driver behavior and provide a prescriptive course of action for improvement. Examples of other search contexts include but are not limited to: (1) multi-task search—accomplish multiple errands, including pick up items at points of interest (e.g., pastries and fruits for breakfasts at a grocery store), refuel/recharge vehicle, and provide areas for rest (e.g., for kids to stretch their legs during long trips); and (2) intent-based search—bundle related categories (e.g., get pastry at supermarket, bakery, café, mall, or convenience store).

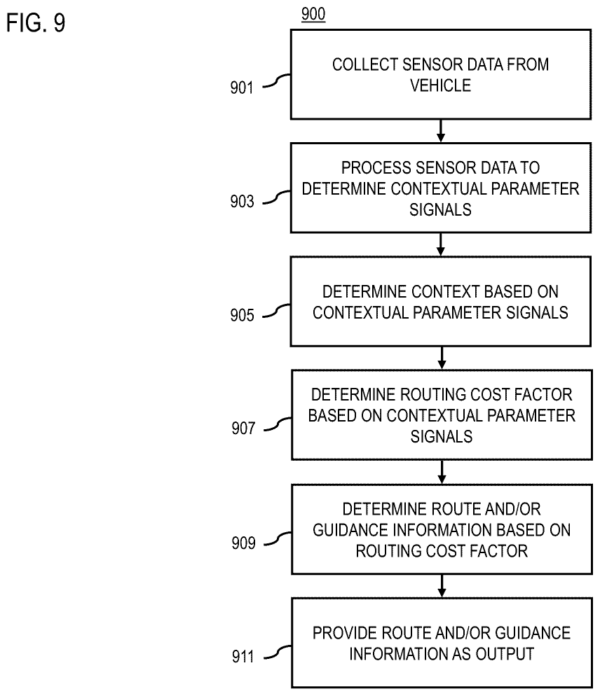

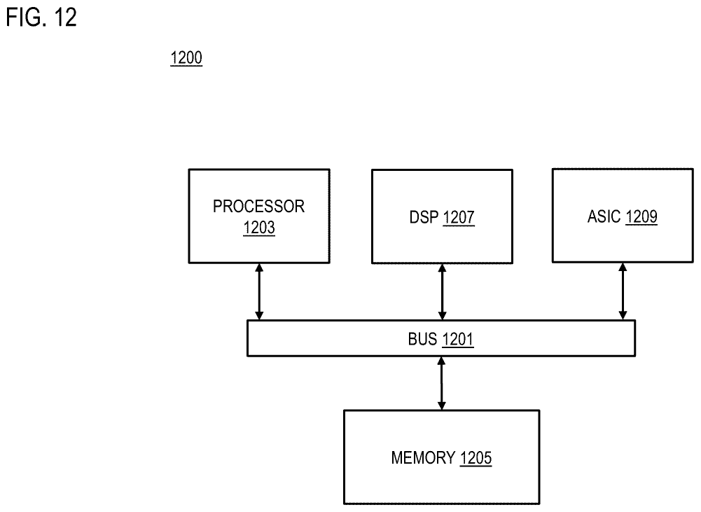

FIG. 9 is a flowchart summarizing a process for providing context-sensitive routing, according to one embodiment. In various embodiments, the mapping/routing platform 109 and/or a local device component of the vehicle 101 and/or UE 117 may perform one or more portions of the process 900 and may be implemented in, for instance, circuitry or a chip set including a processor and a memory as shown in FIG. 12. As such, the mapping/routing platform 109 and/or a local device component can provide means for accomplishing various parts of the process 900, as well as means for accomplishing embodiments of other processes described herein in conjunction with other components of the system 100. Although the process 900 is illustrated and described as a sequence of steps, it is contemplated that various embodiments of the process 900 may be performed in any order or combination and need not include all of the illustrated steps.

In step 901, the mapping/routing platform 109 collects sensor data from one or more in-vehicle sensors 105 of a vehicle 101.

In step 903, the mapping/routing platform 109 processes the sensor data to determine one or more contextual parameter signals associated with the vehicle, one or more passengers of the vehicle, or a combination thereof. By way of example, the one or more contextual parameter signals include a number of the one or more passengers, a weight of the one or more passengers, an age of the one or more passengers, a time of day, or a combination thereof.

In step 905, the mapping/routing platform 109 determines a context associated with a trip engaged by the vehicle or the one or more passengers based on the one or more contextual parameter signals.

In step 907, the mapping/routing platform 109 determines a routing cost factor based on the context. In one embodiment, the routing cost factor includes an efficiency factor, a resilience factor, a reliability factor, a simplicity of route factor, a safety factor, a point of interest discovery factor, or a combination thereof. The efficiency factor relates to a power or fuel consumption of the vehicle, a carbon footprint of the vehicle, or a combination thereof. The resilience factor relates to an availability of one or more back-up routes in case of traffic congestion or an accident. The reliability factor relates to an ability to reach a destination via a selected route given a current power or fuel level of the vehicle. The simplicity of route factor relates to a number of road type changes, complex maneuvers, routing decision points, or a combination thereof. The safety factor relates to a number of vulnerable road users expected to be encountered. The point of interest discovery factor relates to a number of points of interest expected to be encountered, and wherein the points of interest expected to be encountered relates to at least one designated interest of the one or more passengers.

In step 909, the mapping/routing platform 109 determines a navigation route, navigation guidance information, or a combination thereof based on the routing cost factor.

In step 911, the mapping/routing platform 109 provides the navigation route, the navigation guidance information, or a combination thereof as an output.

Returning to FIG. 1, as shown, the system 100 includes the mapping/routing platform 109 for providing context-sensitive routing according to the various embodiments described herein. In one embodiment, the mapping/routing platform 109 has connectivity over the communication network 131 to services platform 127 that provides one or more services 125 that can use the context-sensitive routing for downstream functions. By way of example, the services 125 may be third party services and include but is not limited to mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 125 use the output of the mapping/routing platform 109 to provide services such as navigation, mapping, other location-based services, etc. to client devices.

In one embodiment, the mapping/routing platform 109 may be a platform with multiple interconnected components. The mapping platform and/or trusted location platform may include multiple servers, intelligent networking devices, computing devices, components, and corresponding software for determining map feature identification confidence levels for a given user according to the various embodiments described herein. In addition, it is noted that the mapping/routing platform 109 may be a separate entity of the system 100 of FIG. 1, a part of one or more services 125, a part of the services platform 127, or included within components of the vehicle 101 and/or UE 117.

In one embodiment, content providers 129 may provide content or data (e.g., including sensor data such as image data, probe data, related geographic data, environmental observations, etc.) to the geographic database 115, the mapping/routing platform 109, the services platform 127, the services 125, the vehicles 101, the UEs 117, and/or the applications 119 executing on the UEs 117. The content provided may be any type of content, such as sensor data, imagery, probe data, machine learning (inference) models, permutations matrices, map embeddings, map content, textual content, audio content, video content, image content, etc. In one embodiment, the content providers may provide content that may aid in providing a transaction proof of location according to the various embodiments described herein. In one embodiment, the content providers may also store content associated with the geographic database, mapping platform and/or trusted location platform, services platform, services, and/or any other component of the system. In another embodiment, the content providers may manage access to a central repository of data, and offer a consistent, standard interface to data, such as a repository of the geographic database.

In one embodiment, the vehicles 101 and/or UEs 117 may execute software applications 119 to use the context-sensitive routing data or other data derived therefrom according to the embodiments described herein. By way of example, the applications 119 may also be any type of application that is executable on the vehicles 101 and/or UEs 117, such as autonomous driving applications, routing applications, mapping applications, location-based service applications, navigation applications, device control applications, content provisioning services, camera/imaging application, media player applications, social networking applications, calendar applications, and the like. In one embodiment, the applications 119 may act as a client for the mapping/routing platform 109 and perform one or more functions associated with providing context-sensitive routing alone or in combination with the mapping/routing platform 109.

By way of example, the UEs 117 or the local component of the mapping/routing platform 109 are or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the vehicles 101 and/or UEs 117 can support any type of interface to the user (such as “wearable” circuitry, etc.). In one embodiment, the UEs 117 may be associated with or be a component of a vehicle 101 or any other device.

In one embodiment, the vehicles 101 and/or UEs 117 are configured with various sensors 105 or 123 for collecting or generating sensor data from which the contextual parameter signals 103 are derived. In one embodiment, the sensed data represent sensor data associated with a geographic location or coordinates at which the sensor data was collected, and the polyline or polygonal representations of detected objects of interest derived therefrom to generate the digital map data of the geographic database. By way of example, the sensors 105 or 125 may include a global positioning sensor for gathering location data (e.g., GPS), IMUs, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors 105 or 123 of the vehicles 101 and/or UEs 117 may include light sensors, orientation sensors augmented with height sensors and acceleration sensor, tilt sensors to detect the degree of incline or decline (e.g., slope) along a path of travel, moisture sensors, pressure sensors, etc. In a further example embodiment, sensors about the perimeter of the vehicles 101 and/or UEs 117 may detect the relative distance of the device or vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the vehicles 101 and/or UEs 117 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 131 of the system includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping/routing platform 109, services platform 127, services 125, vehicles 101, UEs 117, and/or content providers 129 communicate with each other and other components of the system using well known, new or still developing protocols. In this context, a protocol includes a set of rules defining how the network nodes within the communication network interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

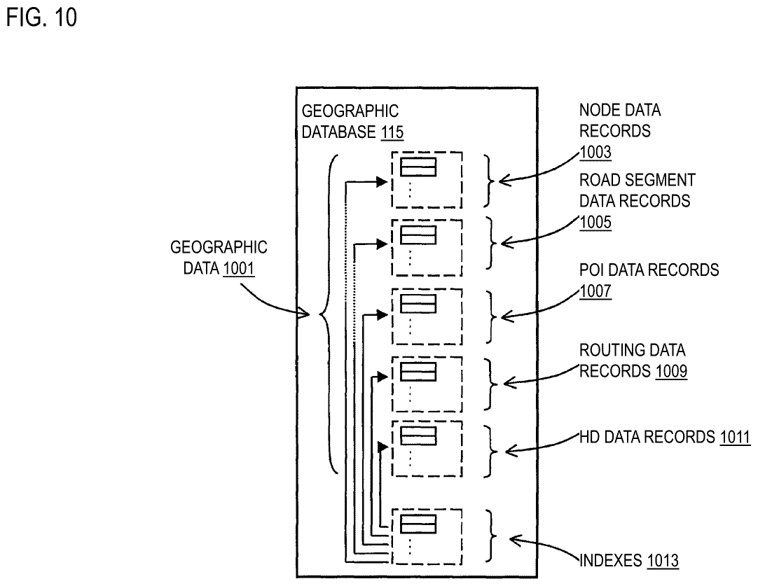

FIG. 10 is a diagram of a geographic database, according to one embodiment. In one embodiment, the geographic database includes geographic data 1001 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 1001. In one embodiment, the geographic database includes high definition (HD) mapping data that provide centimeter-level or better accuracy of map features. For example, the geographic database can be based on Light Detection and Ranging (LiDAR) or equivalent technology to collect billions of 3D points and model road surfaces and other map features down to the number lanes and their widths. In one embodiment, the HD mapping data (e.g., HD data records 1011) and/or other mapping data of the geographic database capture and store details such as but not limited to road attributes and/or other features related to generating speed profile data. These details include but are not limited to road width, number of lanes, turn maneuver representations/guides, traffic lights, light timing/stats information, slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database.
“Node”—A point that terminates a link.
“Line segment”—A straight line connecting two points.
“Link” (or “edge”)—A contiguous, non-branching string of one or more line segments terminating in a node at each end.
“Shape point”—A point along a link between two nodes (e.g., used to alter a shape of the link without defining new nodes).
“Oriented link”—A link that has a starting node (referred to as the “reference node”) and an ending node (referred to as the “non reference node”).
“Simple polygon”—An interior area of an outer boundary formed by a string of oriented links that begins and ends in one node. In one embodiment, a simple polygon does not cross itself.
“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database follows certain conventions. For example, links do not cross themselves and do not cross each other except at a node. Also, there are no duplicated shape points, nodes, or links. Two links that connect each other have a common node. In the geographic database, overlapping geographic features are represented by overlapping polygons. When polygons overlap, the boundary of one polygon crosses the boundary of the other polygon. In the geographic database, the location at which the boundary of one polygon intersects the boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database includes node data records 1003, road segment or link data records 1005, POI data records 1007, routing data records 1009, HD mapping data records 1011, and indexes 1013, for example. More, fewer, or different data records can be provided. In one embodiment, additional data records (not shown) can include cartographic (“carto”) data records, routing data, and maneuver data. In one embodiment, the indexes 1013 may improve the speed of data retrieval operations in the geographic database. In one embodiment, the indexes 1013 may be used to quickly locate data without having to search every row in the geographic database every time it is accessed. For example, in one embodiment, the indexes 1013 can be a spatial index of the polygon points associated with stored feature polygons. In one or more embodiments, data of a data record may be attributes of another data record.

In exemplary embodiments, the road segment data records 1005 are links or segments representing roads, streets, paths, or bicycle lanes, as can be used in the calculated route or recorded route information for determination of speed profile data. The node data records 1003 are end points (for example, representing intersections or an end of a road) corresponding to the respective links or segments of the road segment data records 1005. The road link data records 1005 and the node data records 1003 represent a road network, such as used by vehicles, cars, and/or other entities. Alternatively, the geographic database can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records 1007. The geographic database can also include data about road attributes (e.g., traffic lights, stop signs, yield signs, roundabouts, lane count, road width, lane width, etc.), places, such as cities, towns, or other communities, and other geographic features, such as bodies of water, mountain ranges, etc. Such place or feature data can be part of the POI data records 1007 or can be associated with POIs or POI data records 1007 (such as a data point used for displaying or representing a position of a city).

In one embodiment, the geographic database can also include routing data records 1009 for storing context-sensitive routing data, sensor data (environmental observations), ML models, behavior data, user preferences, and/or any other related data that is used or generated according to the embodiments described herein. By way of example, the routing data records 1009 can be associated with one or more of the node records 1003, road segment records 1005, and/or POI data records 1007 to associate the routing data records 1009 with specific places, POIs, geographic areas, and/or other map features. In this way, the routing data records 1009 can also be associated with the characteristics or metadata of the corresponding records 1003, 1005, and/or 1007.

In one embodiment, as discussed above, the HD mapping data records 1011 model road surfaces and other map features to centimeter-level or better accuracy. The HD mapping data records 1011 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 1011 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 1011 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 1011.

In one embodiment, the HD mapping data records 1011 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database can be maintained by the content provider in association with the mapping platform and/or trusted location platform (e.g., a map developer or service provider). The map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database can be a master geographic database stored in a format that facilitates updating, maintenance, and development. For example, the master geographic database or data in the master geographic database can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by UEs. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing context-sensitive routing may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular device, other network device, and/or other computing device.

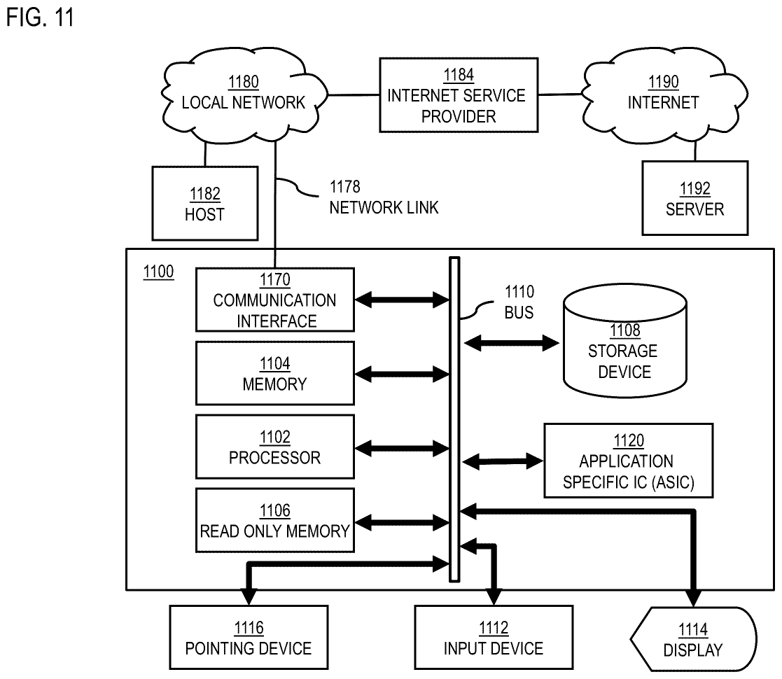

FIG. 11 illustrates a computer system 1100 upon which an embodiment of the invention may be implemented. Computer system 1100 is programmed (e.g., via computer program code or instructions) to provide context-sensitive routing as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to providing context-sensitive routing. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RAM) or other dynamic storage device, stores information including processor instructions for providing context-sensitive routing. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for providing context-sensitive routing, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 131 for providing context-sensitive routing.

The term computer-readable medium is used herein to refer to any medium that participates in providing information to processor 1102, including instructions for execution. Such a medium may take many forms, including, but not limited to, non-volatile media, volatile media and transmission media. Non-volatile media include, for example, optical or magnetic disks, such as storage device 1108. Volatile media include, for example, dynamic memory 1104.

Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system can be deployed in various configurations within other computer systems, e.g., host 1182 and server 1192.

FIG. 12 illustrates a chip set 1200 upon which an embodiment of the invention may be implemented. Chip set 1200 is programmed to provide context-sensitive routing as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to provide context-sensitive routing. The memory 1205 also stores the data associated with or generated by the execution of the inventive steps.

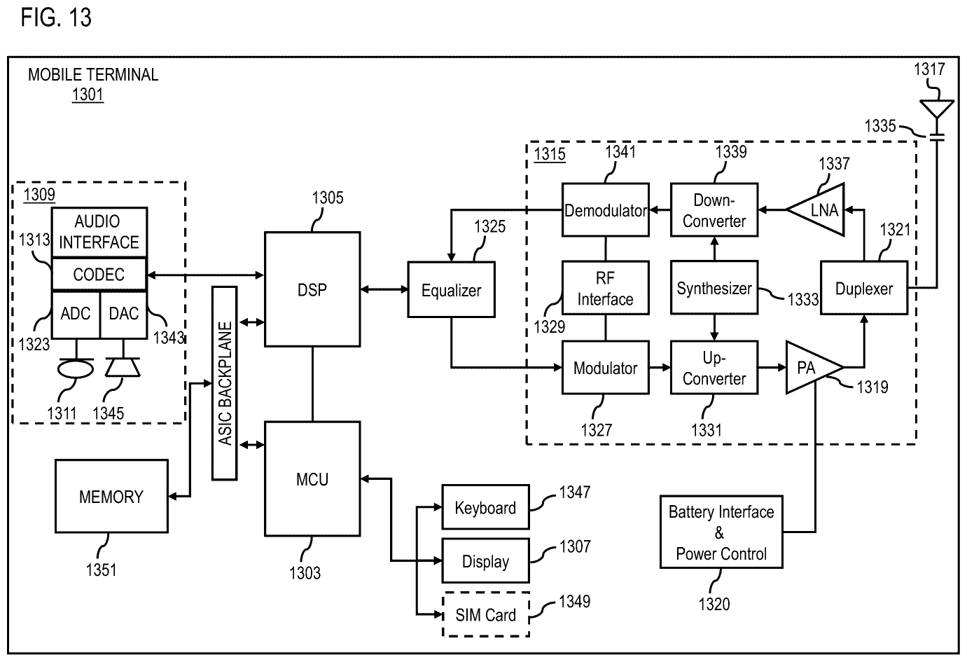

FIG. 13 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile station functions that offer automatic contact matching. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile station 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1325 for compensation of any frequency-dependent impairments that occur during transmission though the air such as phase and amplitude distortion. After equalizing the bit stream, the modulator 1327 combines the signal with an RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303-which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile station 1301 to provide context-sensitive routing. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the station. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile station 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1351 may be, but not limited to, a single memory, CD, DVD, ROM, RAM, EEPROM, optical storage, or any other non-volatile or non-transitory storage medium capable of storing digital data.

An optionally incorporated SIM card 1349 carries, for instance, important information, such as the cellular phone number, the carrier supplying service, subscription details, and security information. The SIM card 1349 serves primarily to identify the mobile station 1301 on a radio network. The card 1349 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
collecting sensor data from one or more in-vehicle sensors of a vehicle;
processing the sensor data to determine one or more contextual parameter signals associated with the vehicle, one or more passengers of the vehicle, or a combination thereof;
determining a context associated with a trip engaged by the vehicle or the one or more passengers based on the one or more contextual parameter signals;
determining a routing cost factor based on the context;
determining a navigation route, navigation guidance information, or a combination thereof based on the routing cost factor; and
providing the navigation route, the navigation guidance information, or a combination thereof as an output.

2. The method of claim 1, wherein the routing cost factor includes an efficiency factor, a resilience factor, a reliability factor, a simplicity of route factor, a safety factor, a point of interest discovery factor, or a combination thereof.

3. The method of claim 2, wherein the efficiency factor relates to a power or fuel consumption of the vehicle, a carbon footprint of the vehicle, or a combination thereof.

4. The method of claim 2, wherein the resilience factor relates to an availability of one or more back-up routes in case of traffic congestion or an accident.

5. The method of claim 2, wherein the reliability factor relates to an ability to reach a destination via a selected route given a current power or fuel level of the vehicle.

6. The method of claim 2, wherein the simplicity of route factor relates to a number of road type changes, complex maneuvers, routing decision points, or a combination thereof.

7. The method of claim 1, wherein the safety factor relates to a number of vulnerable road users expected to be encountered.

8. The method of claim 1, wherein the point of interest discovery factor relates to a number of points of interest expected to be encountered, and wherein the points of interest expected to be encountered relates to at least one designated interest of the one or more passengers.

9. The method of claim 1, wherein the one or more contextual parameter signals include a number of the one or more passengers, a weight of the one or more passengers, an age of the one or more passengers, a time of day, or a combination thereof.

10. The method of claim 1, further comprising:
determining a previous destination, a previous context, or a combination associated with the one or more contextual parameter signals,
wherein the routing cost factor is further based on the previous destination, the previous context, or a combination thereof.

11. The method of claim 1, wherein the navigation route, the navigation guidance information, or a combination thereof is determined further based on one or more multi-task stop options.

12. An apparatus comprising:
at least one processor; and
at least one memory including computer program code for one or more programs,
the at least one memory and the computer program code configured to, with the at least one processor, cause the apparatus to perform at least the following,
collect sensor data from one or more in-vehicle sensors of a vehicle;
process the sensor data to determine one or more contextual parameter signals associated with the vehicle, one or more passengers of the vehicle, or a combination thereof;
determine a context associated with a trip engaged by the vehicle or the one or more passengers based on the one or more contextual parameter signals;
determine a routing cost factor based on the context;
determine a navigation route, navigation guidance information, or a combination thereof based on the routing cost factor; and
provide the navigation route, the navigation guidance information, or a combination thereof as an output.

13. The apparatus of claim 12, wherein the routing cost factor includes an efficiency factor, a resilience factor, a reliability factor, a simplicity of route factor, a safety factor, a point of interest discovery factor, or a combination thereof.

14. The apparatus of claim 12, wherein the one or more contextual parameter signals include a number of the one or more passengers, a weight of the one or more passengers, an age of the one or more passengers, a time of day, or a combination thereof.

15. The apparatus of claim 12, wherein the apparatus is further caused to:
determine a previous destination, a previous context, or a combination associated with the one or more contextual parameter signals,
wherein the routing cost factor is further based on the previous destination, the previous context, or a combination thereof.

16. The apparatus of claim 12, wherein the navigation route, the navigation guidance information, or a combination thereof is determined further based on one or more multi-task stop options.

17. A non-transitory computer-readable storage medium carrying one or more sequences of one or more instructions which, when executed by one or more processors, cause an apparatus to perform:
collecting sensor data from one or more in-vehicle sensors of a vehicle;
processing the sensor data to determine one or more contextual parameter signals associated with the vehicle, one or more passengers of the vehicle, or a combination thereof;
determining a context associated with a trip engaged by the vehicle or the one or more passengers based on the one or more contextual parameter signals;
determining a routing cost factor based on the context;
determining a navigation route, navigation guidance information, or a combination thereof based on the routing cost factor; and
providing the navigation route, the navigation guidance information, or a combination thereof as an output.

18. The non-transitory computer-readable storage medium of claim 17, wherein the routing cost factor includes an efficiency factor, a resilience factor, a reliability factor, a simplicity of route factor, a safety factor, a point of interest discovery factor, or a combination thereof.

19. The non-transitory computer-readable storage medium of claim 17, wherein the one or more contextual parameter signals include a number of the one or more passengers, a weight of the one or more passengers, an age of the one or more passengers, a time of day, or a combination thereof.

20. The apparatus of claim 17, wherein the apparatus is caused to further perform:
determining a previous destination, a previous context, or a combination associated with the one or more contextual parameter signals,
wherein the routing cost factor is further based on the previous destination, the previous context, or a combination thereof.
